(19) United States
(12) Patent Application Publication
(10) Pub. No.: US 2024/0140039 A1
(43) Pub. Date: May 2, 2024

(54) USING A SEGMENTED THREE-DIMENSIONAL MODEL TO CONTROL MULTIPLE PRINTHEADS TO PERFORM PARALLEL, SEGMENTED THREE-DIMENSIONAL PRINTING

(71) Applicant: International Business Machines Corporation, Armonk, NY (US)

(72) Inventors: Fang Lu, Billerica, MA (US); Jeremy R. Fox, Georgetown, TX (US); Tushar Agrawal, West Fargo, ND (US); Sarbajit K. Rakshit, KOLKATA (IN)

(21) Appl. No.: 18/051,181

(22) Filed: Oct. 31, 2022

(51) Int. Cl. B29C 64/393; B29C 64/209; B33Y 50/02

(52) U.S. Cl. CPC B29C 64/393; B29C 64/209; B33Y 50/02

(57) ABSTRACT

Embodiments of the invention are directed to a computer-implemented method. A non-limiting example of the computer-implemented method includes accessing, using a processor system, a segmented three-dimensional (3D) model of a 3D physical object, the segmented 3D model including a plurality of 3D model segments. Instructions of a first 3D model segment of the plurality of 3D model segments control a first printhead of a multiple-printhead (MPH) 3D printer to print a first segment of the 3D physical object on a first print base of the MPH 3D printer. Instructions of a second 3D model segment of the plurality of 3D model segments control a second printhead of the MPH 3D printer to print a second segment of the 3D physical object on a second print base of the MPH 3D printer.

### BACKGROUND

The present invention relates in general to programmable computers that control manufacturing equipment. More specifically, the present invention relates to computing systems, computer-implemented methods, and computer program products operable to use a segmented three-dimensional (3D) model to control multiple printheads of a printing devices to perform parallel, segmented three-dimensional (3D) printing.

3D printing technology, also known as additive manufacturing, refers to a machine that fabricates a 3D physical object by using a printhead to successively form or deposit layers of material under control of a computer that contains a 3D electronic model of the physical object. The 3D electronic model logically slices the physical object into several layers and provides instructions to the machine. The instructions control the machine, and more specifically the printhead of the machine, to form/deposit each layer successively until the physical object is completed. The physical objects fabricated through 3D printing processes have a variety of shapes and geometries.

### SUMMARY

Embodiments of the invention are directed to a computer-implemented method. A non-limiting example of the computer-implemented method includes accessing, using a processor system, a segmented three-dimensional (3D) model of a 3D physical object, the segmented 3D model including a plurality of 3D model segments. Instructions of a first 3D model segment of the plurality of 3D model segments control a first printhead of a multiple-printhead (MPH) 3D printer to print a first segment of the 3D physical object on a first print base of the MPH 3D printer. Instructions of a second 3D model segment of the plurality of 3D model segments control a second printhead of the MPH 3D printer to print a second segment of the 3D physical object on a second print base of the MPH 3D printer.

Embodiments of the invention are also directed to computer systems and computer program products having substantially the same features as the computer-implemented method described above.

Additional features and advantages are realized through techniques described herein. Other embodiments and aspects are described in detail herein. For a better understanding, refer to the description and to the drawings.

### BRIEF DESCRIPTION OF THE DRAWINGS

The subject matter which is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 depicts a simplified block diagram illustrating a system in accordance with embodiments of the invention;

FIG. 2A depicts a simplified block diagram illustrating a system in accordance with embodiments of the invention;

FIG. 2B depicts a simplified block diagram illustrating a system in accordance with embodiments of the invention;

FIG. 2C depicts a combined system diagram and flow diagram illustrating a printing device and a computer-controlled method in accordance with embodiments of the invention;

FIG. 2D depicts a combined system diagram and flow diagram illustrating a printing device and a computer-controlled method in accordance with embodiments of the invention;

FIG. 3 depicts a collapsible base in accordance with embodiments of the FIG. 4 depicts a three-dimensional (3D) physical object capable of being formed in accordance with embodiments of the invention;

FIG. 5 depicts a flow diagram illustrating a computer-implemented or computer-controlled method in accordance with embodiments of the invention;

FIG. 6 depicts a machine learning system that can be utilized to implement aspects of the invention;

FIG. 7 depicts a learning phase that can be implemented by the machine learning system shown in FIG. 6; and

FIG. 8 depicts details of an exemplary computing environment operable to implement embodiments of the invention.

In the accompanying figures and following detailed description of the disclosed embodiments, the various elements illustrated in the figures are provided with three-digit reference numbers. In some instances, the leftmost digits of each reference number correspond to the figure in which its element is first illustrated.

### DETAILED DESCRIPTION

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Many of the functional units of the systems described in this specification have been labeled as modules. Embodiments of the invention apply to a wide variety of module implementations. For example, a module can be implemented as a hardware circuit including custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like. Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together, but can include disparate instructions stored in different locations which, when joined logically together, function as the module and achieve the stated purpose for the module.

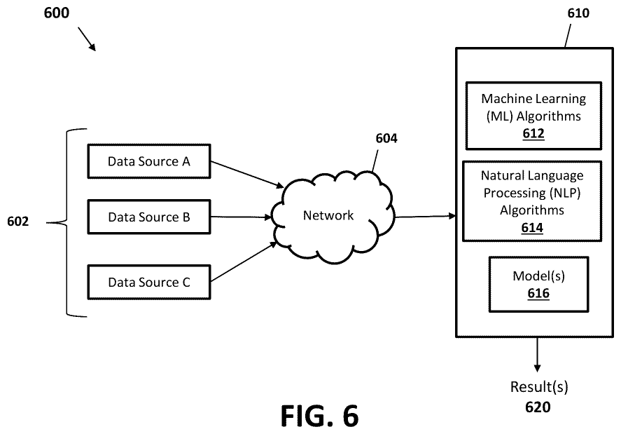

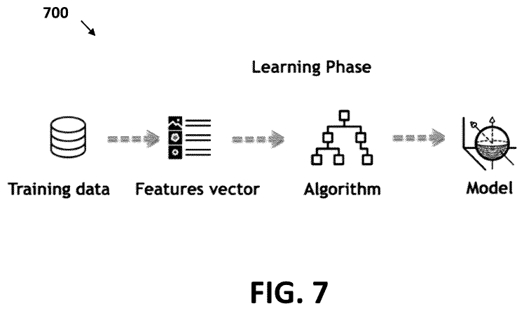

Many of the functional units of the systems described in this specification have been labeled as models. Embodiments of the invention apply to a wide variety of model implementations. For example, the models described herein can be implemented as machine learning algorithms and natural language processing algorithms configured and arranged to uncover unknown relationships between data/information and generate a model that applies the uncovered relationship to new data/information in order to perform an assigned task of the model. In aspects of the invention, the models described herein can have all of the features and functionality of the models depicted in FIGS. 6, and 7, which are described in greater detail subsequently herein.

Turning now to an overview of aspects of the invention, embodiments of the invention provide computing systems, computer-implemented methods, and computer program products operable to use a segmented three-dimensional (3D) model to control multiple printheads of a printing devices to perform parallel, segmented three-dimensional (3D) printing. In aspects of the invention, a novel version of computer-aided-design (CAD) technology is used to create a 3D model of a 3D physical object then segment the 3D model to generate a segmented 3D model having a plurality of separate but related 3D model segments. Each 3D model segment is separate in that it is designed to control a corresponding printhead of a multiple printhead (MPH) 3D printer to print a segment of the 3D physical object. Each 3D model is related in that the segments printed by the 3D model segments (and hence the 3D model segments as well) have been selected such that the separate segments can be assembled and attached (e.g., using adhesive, glue, other filament, and the like) post-printing to form a version of the 3D physical object having substantially the same physical characteristics or physical integrity as a version of the 3D physical object created using a non-segmented 3D model of the 3D physical object to control a single printhead of a 3D printer. In some embodiments of the invention, the segmentation operations are integrated with the operations that create the 3D model.

In embodiments of the invention, the metes and bounds of each 3D model segment can be determined based at least in part on a variety of segmentation constraints. In embodiments of the invention, the segmentation constraints include structural constraints of the 3D physical object; constraints of the MPH 3D printer; and assembly constraints associated with assembling the separate printed segments into the 3D physical object. In embodiments of the invention, the metes and bounds of each 3D model segment and its associated 3D physical printed segment can also be determined based at least in part on a corpus of historical segmentation metes and bounds and segment assembly results for a variety 3D physical objects. The assembly results include example metes and bounds for 3D physical segments that were successfully assembled into an associated 3D physical object, as well as example metes and bounds for 3D physical segments that were not successfully assembled into as associated 3D physical object. In embodiments of the invention, the metes and bounds of a set of 3D model segments and the associated 3D physical segments can be generated using any combination of structural constraints of the 3D physical object; constraints of the MPH 3D printer; assembly constraints associated with assembling the separate printed segments into the 3D physical object; and the corpus of historical segmentation metes and bounds and assembly results for a variety 3D physical objects. In some embodiments of the invention, the novel version of CAD technology disclosed herein is operable to use one or more machine learning (ML) algorithms trained to select or predict the metes and bounds of a set of 3D model segments and its associated 3D physical segments using any combination of structural constraints of the 3D physical object; constraints of the MPH 3D printer; assembly constraints associated with assembling the separate printed segments into the 3D physical object; and the corpus of historical segmentation metes and bounds and assembly results for a variety 3D physical objects.

In embodiments of the invention, a controller is used to execute the 3D model segments to control corresponding printheads of the MPH 3D printer to print corresponding 3D segments of the 3D physical object. In embodiments of the invention, the controller can also control an assembly mechanism operable to automatically assemble the printed 3D segments into the 3D physical object. In some embodiments of the invention, the assembly mechanism can be a robotic arm.

In accordance with embodiments of the invention, the controller is further used to execute the instructions of the 3D model segments to control corresponding printheads of the MPH 3D printer to print corresponding 3D segments of the 3D physical object substantially in parallel. In embodiments of the invention where the metes and bounds of the physical segments are such that each 3D segment prints in substantially the same amount of time, the controller can control the parallel printing operations of the printheads of the MPH 3D printer such that they all start and end their print operations at substantially the same time. In embodiments of the invention where the metes and bounds of the physical segments are such that the 3D segments prints in substantially different amounts of time, the controller can control the parallel printing operations of the printheads of the MPH 3D printer such that the print start times are staggered so that printing for all printheads ends at substantially the same time, which allows all of the printed segments to experience the same post-printing dwell time prior to segment assembly. The need for post-printing dwell time can vary based on a variety of factors, including the material, size, and shape of the printed segments.

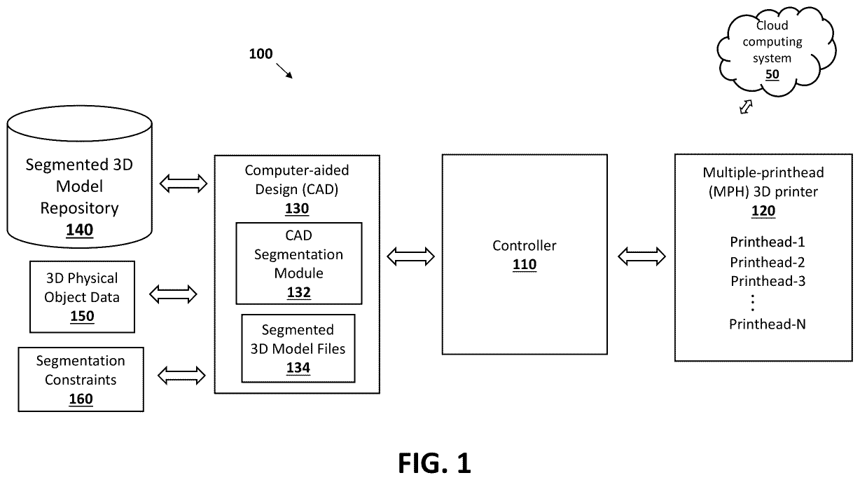

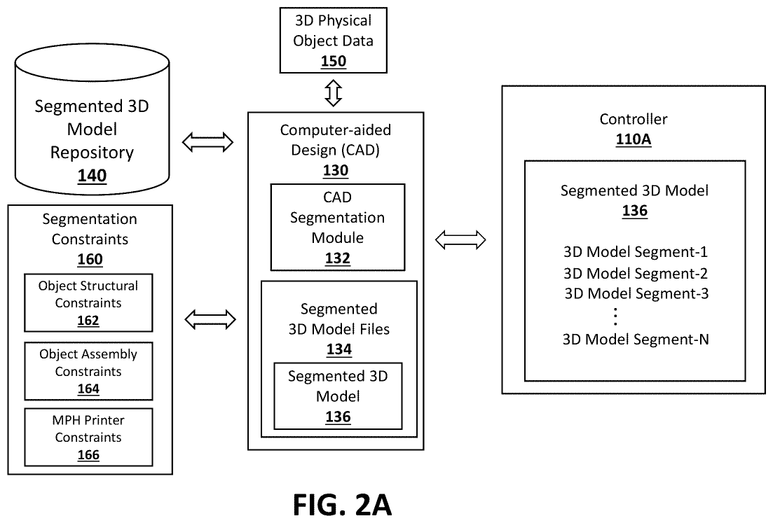

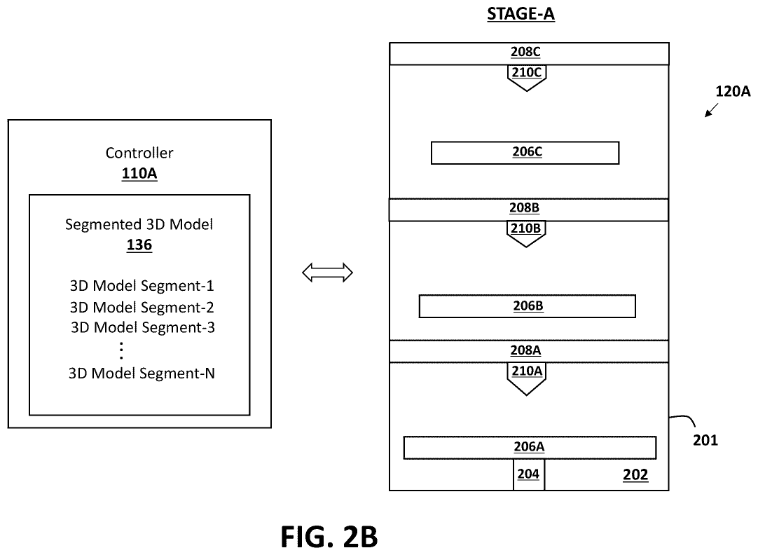

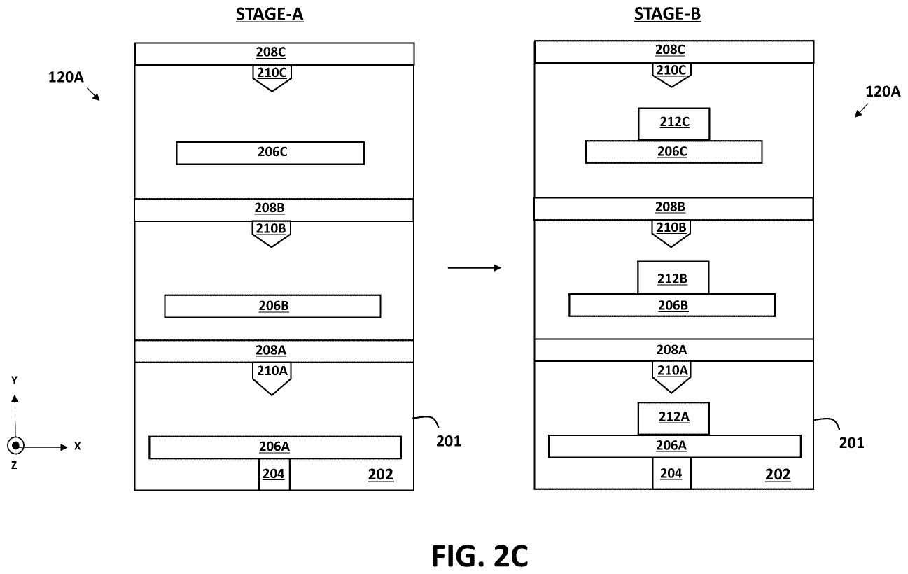

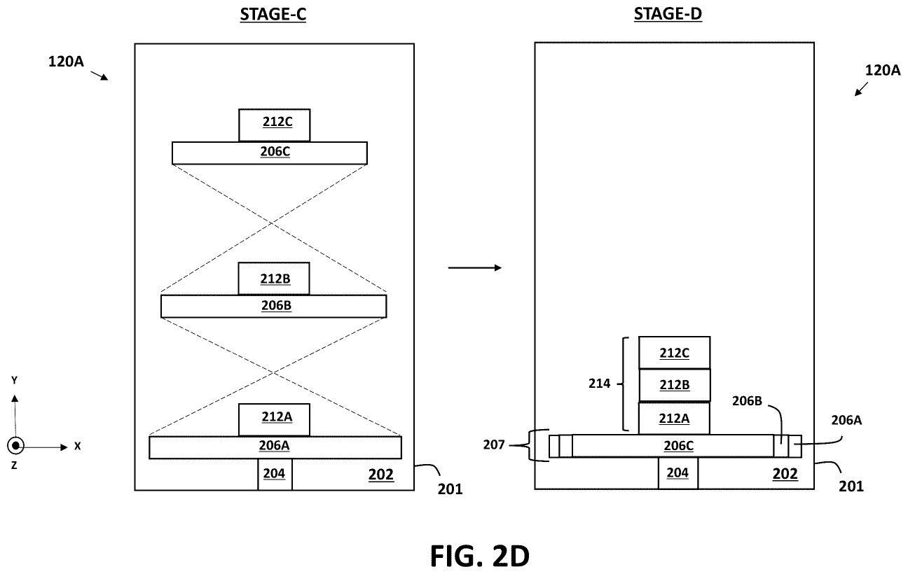

Turning now to a more detailed description of the aspects of the present invention, FIG. 1 depicts a simplified block diagram illustrating a system 100 in accordance with embodiments of the invention. The system 100 includes a controller 110, an MPH 3D printer 120, a CAD module 130, and a segmented 3D model repository 140, configured and arranged as shown. In accordance with aspects of the invention, the MPH 3D printer 120 includes multiple printheads, which are identified in FIG. 1 as Printhead-1, Printhead-2, and Printhead-3 through Printhead-N, where N is any whole number greater than one (1). In accordance with aspects of the invention, the controller 110 is operable to load a segmented 3D model (e.g., segmented 3D model 136 shown in FIG. 2A) from a segmented 3D model file 134 of the CAD module 130. In accordance with embodiments of the invention, the segmented 3D model includes a plurality of 3D model segments. In accordance with some embodiments of the invention, each of the 3D model segments includes instructions operable to control a corresponding one of Prinhead-1 through Printhead-N to form/deposit a corresponding 3D segment of a 3D physical object (e.g., 3D physical object 214A shown in FIG. 4).

The CAD module 130 includes a full range of CAD software functionality operable to design a 3D electronic model of a 3D physical object (e.g., 3D physical object 214A shown in FIG. 4) based on 3D physical object data 150 having the size, dimensions, materials, etc. of the 3D physical object. In accordance with aspects of the invention, the CAD module 130 further includes a CAD segmentation module 132 operable to segment the 3D electronic model into a plurality of 3D model segments (e.g., the segmented 3D model 136 shown in FIG. 2A), which are stored in a segmented 3D model files 134. In embodiments of the invention, the segmentation module 132 is operable to perform model segmentation operations based on any combination of the segmentation constraints 160, the 3D physical object data, and/or the segmented 3D model repository 140. In general, the segmentation constraints 160 include various types of limits on how the 3D physical object can be segmented, and the segmented 3D model repository 140 includes various model segmentations that have been successfully used to print 3D physical object segments then assemble the printed 3D physical object segments into the 3D physical object (e.g., 3D physical object 214A shown in FIG. 4). In accordance with aspects of the invention, each of the plurality of 3D model segments provides instructions to a corresponding printhead (e.g., Printhead-1, Printhead-2, Printhead-3, etc.) of the MPH 3D printer 120, and the printheads of the MPH 3D printer 120 use the instructions to build or print a segment of the 3D physical object. Each of the printheads of the MPH 3D printer 120 builds its assigned segment of the 3D physical object by depositing material onto a substrate known as a print bed or a print base. Each of the printheads of the MPH 3D printer 120 can be configured to include a nozzle connected to a filament of material. The material is extruded out the nozzle and onto a print bed assigned to the printhead. After completing the base layer at the bottom of the corresponding print bed, each printhead of the MPH 3D printer 120 works on the next layer. Each of the printheads of the MPH 3D printer 120 is governed by rules or instructions included in its corresponding 3D model segment of the segmented 3D model 136. Each of the printheads of the MPH 3D printer 120 uses the information contained in its corresponding segment of the segmented 3D model 136 to determine how much material needs to be deposited and where, exactly, the material should be deposited. In accordance with aspects of the invention, the CAD module 130 is operable to provide the segmented 3D model 136 to the controller 110. In some embodiments of the invention, the CAD segmentation module 132 can be implemented as one or more machine learning (ML) algorithms (e.g., the classifier system 600 shown in FIG. 6) trained to perform the task of using any combination of the information of the segmented 3D model repository 140, the 3D physical object data 150, and/or the segmentation constraints 160 to predict how the 3D physical object's design should be segmented in order to allow the 3D physical object segments to be printed in parallel using the multiple printheads of the MPH 3D printer 120 then joined post-deposition to form the completed 3D physical object having required characteristics, including, for example, a required level of structural integrity.

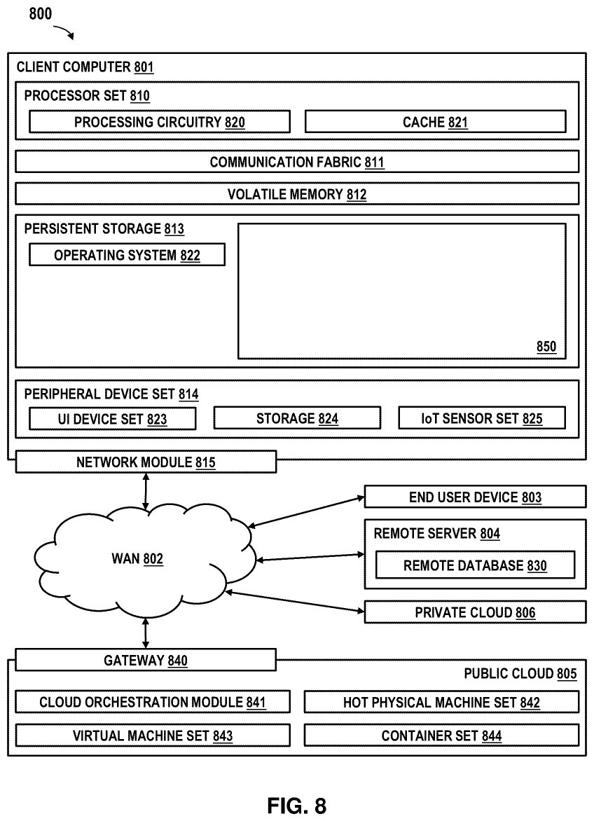

A cloud computing system 50 is in wired or wireless electronic communication with the system 100. The cloud computing system 50 can supplement, support or replace some or all of the functionality of the various components of the system 100. Additionally, some or all of the functionality of the system 100 can be implemented as a node of the cloud computing system 50. Additional details of cloud computing features of embodiments of the invention are depicted by the computing environment 800 shown in FIG. 8 and described in greater detail subsequently herein.

In accordance with aspects of the invention, the system 100 is operable to perform a computer-implemented method that includes using the controller 110 to access a segmented 3D model 136 (shown in FIG. 2A) of a 3D physical object (e.g., the 3D physical object 214A shown in FIG. 4). In accordance with aspects of the invention, the segmented 3D model 136 includes a plurality of 3D model segments (e.g., the 3D model segment-1 through the 3D model segment-N shown in FIG. 2A). In accordance with aspects of the invention, each of the 3D model segments is operable to control a corresponding one of the printheads (e.g., a corresponding one of Printhead-1 through Printhead-N) of the MPH 3D printer 120 to print a corresponding 3D segment of the 3D physical object

In accordance with aspects of the invention, the controller 110 is operable to use the 3D model segments of the segmented 3D model 136 (shown in FIG. 2A) to control the printheads of the MPH 3D printer 120 substantially in parallel. In accordance with embodiments of the invention, CAD module 130 is operable to determine the metes and bounds of the 3D model segments of the segmented 3D model 136 based at least in part on a weight distribution of the 3D physical object. In accordance with embodiments of the invention, CAD module 130 is operable to determine the metes and bounds of the 3D model segments of the segmented 3D model 136 based at least in part on a shape of the 3D physical object. In accordance with embodiments of the invention, CAD module 130 is operable to determine the metes and bounds of the 3D model segments of the segmented 3D model 136 based at least in part on an ability to join the printed segments of the 3D physical object to form a completed 3D physical object. In accordance with embodiments of the invention, CAD module 130 is operable to determine the metes and bounds of the 3D model segments of the segmented 3D model 136 based at least in part on a corpus of previously-implemented segmented 3D models in the segmented 3D model repository 140.

FIGS. 2A, 2B, 2C and 2D depict additional details of how the MPH 3D printer 120 can be implemented as an MPH 3D printer 120A; how the controller 110 can be implemented as a controller 110A; and additional details of how the controller 110A can control the MPH 3D printer 120A through fabrication stages A-D (shown in FIGS. 2B, 2C, and 2D), all in accordance with embodiments of the invention. Turning first to FIG. 2A, FIG. 2A depicts the CAD module 130, the controller 110A, and the segmented 3D model repository 140, configured and arranged as shown. The CAD module 130 has used the 3D physical object data 150 to generate an unsegmented 3D model of a 3D physical object. The CAD module 130 uses the CAD segmentation module 132 to segment the unsegmented 3D model to form the segmented 3D model 136 and store the same in the segmented 3D model file 134. In embodiments of the invention, the CAD module 130 is operable to form the segmented 3D model 136 using any combination of the object structural constraints 162 of the 3D physical object; the MPH 3D printer constraints 166; the object assembly constraints 164 associated with assembling the separate printed segments into the 3D physical object; and the corpus of historical segmentation metes and bounds and assembly results for a variety 3D physical objects stored in the segmented 3D model repository 140. In some embodiments of the invention, the CAD segmentation module 132 operable to use one or more ML algorithms trained to select or predict the metes and bounds of the 3D model segments of the segmented 3D model 136 and the associated physical segments using any combination of the object structural constraints 162 of the 3D physical object; the MPH 3D printer constraints 166; the object assembly constraints 164 associated with assembling the separate printed segments into the 3D physical object; and the corpus of historical segmentation metes and bounds and assembly results for a variety 3D physical objects stored in the segmented 3D model repository 140.

FIG. 2B depicts the controller 110A and the MPH 3D printer 120A when the MPH 3D printer 120A is at STAGE-A, which means that printing has yet to commence. The controller 110A has accessed a segmented 3D model 136 that includes a plurality of 3D model segments, which are shown as 3D model segement-1 through 3D model segment-N. FIG. 2B depicts a cross-sectional view of a portion of the MPH 3D printer 120A in accordance with embodiments of the present invention. The MPH 3D printer 120A includes a main body 201 having an interior 202. The interior 202 houses a first printhead assembly formed from a first printhead support 208A interconnected to a first printhead 210A. The first printhead assembly 208A/210A is positioned above a first print base 206A that is interconnected to base support 204. In accordance with aspects of the invention, the first print base 206A, a second print base 206B, and a third print base 206C form a collapsible or telescopic print base 206A/206B/206C (e.g., as shown in FIG. 2D). In FIG. 2B, the collapsible print base 206A/206B/206C is in an expanded position where the print bases are separated from one another as shown in FIG. 2B. The interior 202 further houses a second printhead assembly formed from a second printhead support 208B interconnected to a second tool (or print) head 210B. The second printhead assembly 208B/210B is positioned above the second print base 206B. The interior 202 further houses a third printhead assembly formed from a third printhead support 208C interconnected to a third (or print) head 210C. The third printhead assembly 208C/210C is positioned above the third print base 206C. For ease of illustration and explanation, only 3 printhead assemblies and print bases are shown. However, it is understood that any number of printhead assemblies and corresponding print bases can be provided.

MPH 3D printer 120A represents an automated manufacturing apparatus. In an embodiment of the present invention, MPH 3D printer 120A may be, for example, a 3D printer. In embodiments of the invention, the MPH 3D printer 120A can implement, for example, an additive manufacturing process such as fused filament fabrication in printing a 3D physical object (e.g., 3D physical object 214A shown in FIG. 4). The 3D physical object may be a part, item, object, or the like, such as of a printed circuit board. The 3D physical object is segmented into three segments and each segment is printed on a corresponding one of the print bases 206A, 206B, 206C. In embodiments of the invention, the MPH 3D printer 120A may implement, for example, a spatial orientation and positioning system that can include control systems, actuators, sensors, hardware, and the like, to spatially orient and position the print assemblies 210A/208A, 210B/208B, 210C/208C by way of the print bases 206A, 206B, 206C. Spatial orientation and positioning of the print bases 206A, 206B, 206C or the printhead assemblies 208A/210A, 208B/210B, 208C/210C, or both, can occur along or about one or more of the X-, Y-, and Z-axes of a three-dimensional Cartesian coordinate system defined with respect to MPH 3D printer 120A. A closed loop control system can be implemented by the MPH 3D printer 120A to actuate motors, such as DC stepper motors, to respectively orient and position the print bases 206A, 206B, 206C or the printhead assemblies 208A/210A, 208B/210B, 208C/210C, or both, according to control data generated by encoders associated with the DC stepper motors under control of the segmented 3D model 136. The MPH 3D printer 120A can include automated stereoscopic computer vision to monitor each printed layer during printing to ensure that an item such as the 3D physical object prints correctly. Other spatial orientation and positioning systems can be used as a matter of design choice based on a particular application at-hand.

The printhead supports 208A, 208B, 208C each represents part of the spatial orientation and positioning system of MPH 3D printer 120A used to support and spatially orient and position the printheads 210A, 210B, 210C in printing the 3D physical object. In embodiments of the invention, each of the printhead supports 208A, 208B, 208C can include, for example, a mount, carriage, chuck, or the like, to support and spatially orient and position one or more instances of the printheads 210A, 210B, 210C within the interior 202 of the MPH 3D printer 120A. In embodiments of the invention, the printhead supports 208A, 208B, 208C can, for example, support its corresponding printhead 210A, 210B, 210C for spatial orientation and positioning within interior 202 along or about one or more of the X-, Y-, and Z-axes of the MPH 3D printer 120A. In embodiments of the invention, the printhead supports 208A, 208B, 208C can include, for example, a translational stage such as a one-, two-, three-, four-, five-, or six-axis stage, or the like. For example, the printhead supports 208A, 208B, 208C can each be formed of two one-axis stages, connected to effect two-axis stage functionality in operation, and so on. In embodiments of the invention, the printhead supports 208A, 208B, 208C can each further include, for example, a linear bearing, rail, track, race, guide rod, or the like. For example, the printhead supports 208A, 208B, 208C can each include a mount for receiving and supporting the printheads 210A, 210B, 210C, the mount being attached to one or more linear bearings, to effect spatial orientation and positioning of the printheads 210A, 210B, 210C within the interior 202 during operation of the MPH 3D printer 120A.

Each of the printheads 210A, 210B, 210C represents an extruder of the MPH 3D printer 120A used in printing 3D physical object. In embodiments of the invention, the printheads 210A, 210B, 210C can each be, for example, an extruder or the like. In embodiments of the invention, the printheads 210A, 210B, 210C can each implement, for example, an additive manufacturing process such as fused filament fabrication in printing the 3D physical object. During operation, the printheads 210A, 210B, 210C each receives or draws material, in the form of plastic or metallic filament, from a supply for heating, melting, and extruding of the drawn material from nozzles of the printheads 210A, 210B, 210C. The extruded material is formed and deposited in layers on or along a corresponding surface of a corresponding one of the print bases 206A, 206B, 206C to form the printed 3D physical object. In embodiments of the invention, the material may include, for example, plastic material such as acrylonitrile butadiene styrene (ABS), polylactic acid (PLA), high-impact polystyrene (HIPS), thermoplastic polyurethane (TPU), aliphatic polyamides (nylon), polypropylene (PP), polyetherimide (PEI), polyether ether ketone (PEEK), acrylonitrile styrene acrylate (ASA), polycarbonate (PC), polyethylene terephthalate (PET), polyoxymethylene (POM), polyvinyl alcohol (PVA), or the like. In embodiments of the invention, the material may otherwise include wood fill material, metallic material, conductive material, or the like.

The print bases 206A, 206B, 206C each represents a build surface used by the MPH 3D printer 120A to deposit extruded material for support in printing in parallel segments of the 3D physical object. In embodiments of the present invention, the print bases 206A, 206B, 206C can be or include, for example, a print bed, build plate, platform, table, board, sheet, laminate, or the like. A top surface of each of the print bases 206A, 206B, 206C receives and supports extruded material deposited by a corresponding one of the printheads 210A, 210B, 210C in printing a corresponding segment of the 3D physical object. A size or surface area of each of the print bases 206A, 206B, 206C, such as with respect to the top surface, can be chosen according to a size of an item to be printed, such as the 3D physical object.

Base support 204 represents part of the spatial orientation and positioning system of MPH 3D printer 120A used to support and spatially orient and position the base assemblies 206A/206B/206C in printing corresponding segments of the 3D physical object. In embodiments of the invention, the base support 204 can be, for example, a robotic arm, or the like. In the embodiment, the base support 204 can include, for example, a platform, mount, carriage, chuck, end effector, or the like, to attach to, support and spatially orient and position the base assemblies 206A, 206B, 206C within, or inside, outside, and about the interior 202 of MPH 3D printer 120A. The robotic arm can include stereoscopic computer vision. In embodiments of the invention, the base support 204 can, for example, support the base assemblies 206A, 206B, 206C for spatial orientation and positioning within, outside, and about the interior 202 along or about one or more of the X-, Y-, and Z-axes of the MPH 3D printer 120A. In embodiments of the invention, upon completion of printing, the base support 204 can move the base assemblies 206A, 206B, 206C together with corresponding segments of the 3D physical object outside of interior 202, for joining the segments of the 3D physical object (e.g., by collapsing the base assemblies 206A, 206B, 206C as shown in FIG. 2C) and detachment of the joined 3D physical object from the collapsed base assemblies 206A, 206B, 206C. In embodiments of the invention, the base support 204 can be, for example, a conveyor belt, or the like.

FIG. 2C depicts the MPH 3D printer 120A as it moves from STAGE-A to STAGE-B where printhead 210A, under control of 3D model segment-1, prints 3D segment 212A; printhead 210B, under control of 3D model segment-2, prints 3D segment 212B; and printhead 210C, under control of 3D model segment-3, prints 3D segment 212C.

FIG. 2D depicts the MPH 3D printer 120A as it moves to STAGE-C from STAGE-B. At STAGE-B, the segments 212A, 212B, 212C have been printed in parallel, and the print assemblies 208A/210A, 208B/208B, 208C/210C have been moved away from the base assemblies 206A, 206B, 206C, either by removing the print assemblies 208A/210A, 208B/208B, 208C/210C from the main body 201 or by moving the base assemblies 206A, 206B, 206C outside the main body 201.

FIG. 2D also depicts the MPH 3D printer 120A as it moves from the STAGE-C to STAGE-D where the base assemblies 206A, 206B, 206C are collapsed to form a collapsed base assembly 207, thereby brining the segments 212A, 212B, 212C into contact with one another. The segments 212A, 212B, 212C can now be joined together to form a 3D physical object 214 using any suitable technique. The joined 3D physical object 214 can be removed from the collapsed base assembly 207 using any suitable technique.

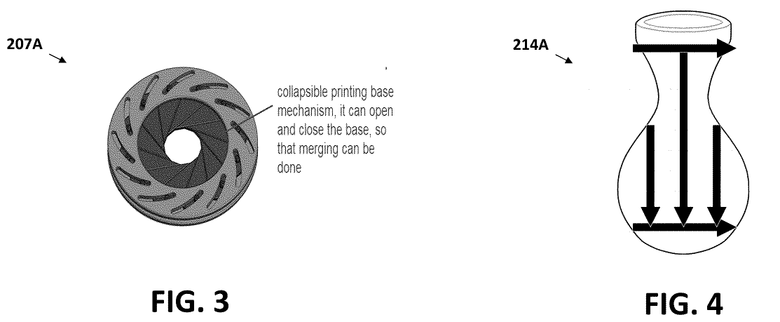

FIG. 3 depicts an example of how the printhead assembly 207 can be implemented as a collapsible printing base mechanism 207A, configured and arranged as shown. The collapsible printing base mechanism 207A can be opened for printing (e.g., STAGE-A, STAGE-B, and STAGE-C) or collapsed for marching the segments 212A, 212B, 212C (e.g., STAGE-D).

FIG. 4 depicts an example of how the 3D physical object 214 can be implemented as a 3D physical object 214A. As depicted, the 3D physical object 214A is a 3D hollow vase structure. As depicted by the horizontal and vertical axes (i.e., the directional arrows), the 3D physical object 214A can be segmented horizontally, vertically, or using a combination of horizontal and vertical segments. When splitting the 3D physical object 214A horizontally and vertically, the embodiments of the invention take into consideration what type of materials need to be used for which segment of the printed objects. This is to ensure the robustness of the overall objects when different pieces are assembled together later on.

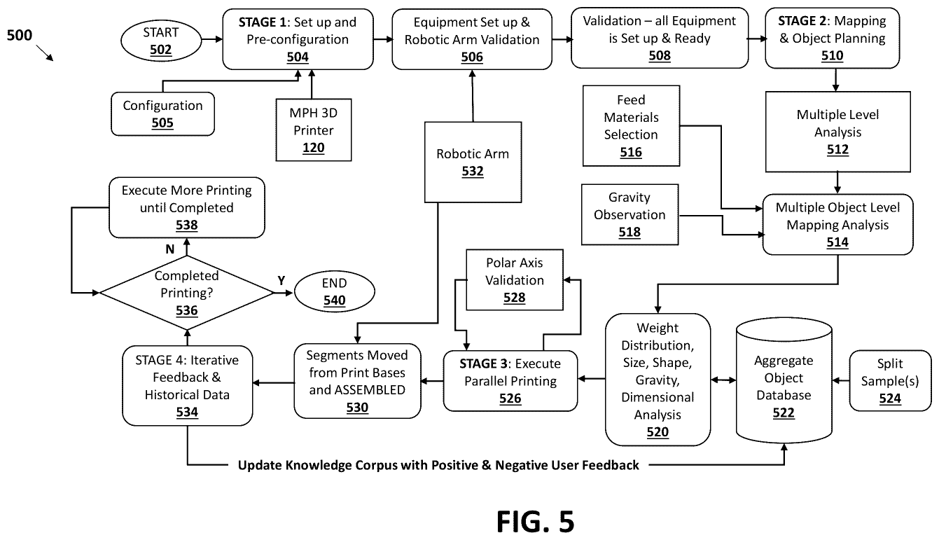

FIG. 5 depicts a methodology 500 in accordance with embodiments of the invention. As shown in FIG. 5, the methodology 500 starts at block 502 then moves to block 504 where STAGE 1 depicts setup and pre-configuration that are performed using configuration data 505 that describes the features (e.g., number of printheads) and capabilities (e.g., printhead speeds, filament materials capabilities, collapsible print base assembly capabilities, etc.) of the MPH 3D printer 120. At block 506, equipment setup and robotic arm validation operations are performed for setting up a robotic arm 532. In some embodiments of the invention, the robotic arm 532 can be configured to perform the relevant assembly operations for printed segment. In some of the embodiments of the invention, the robotic arm 532 can work in tandem with other components, for example, the collapsible print base 207, to perform the relevant assembly operations for printed segments. In some embodiments of the invention, each printhead can be configured to include an instance of the arm 532 having a robotic gripper; when an object is printed in each level and ready to assemble, then the collapsible print base can be removed, but before the print base is removed (or collapsed), the grippers can grip the segments of the 3D physical object and perform the necessary assembly operations. At block 508, validation operations are performed to ensure that all equipment is set up and ready.

At block 510, STAGE 2 depicts mapping and object planning for multiple level, in parallel printing, which is covered by blocks 512, 514, 516, 518. At block 512 multiple level analysis is performed to determine multiple printhead engagement and the printhead and print base combinations associated with each level of the multi-level printing. At block 514, multiple object level mapping analysis is performed based on the feed material selections 516 and gravity observations 518 for the segments of the 3D physical object. Feed materials can be a single filament or can be formed from multiple different filament materials or different filament colors. Proper distribution of center of gravity in each printed segment is analyzed at block 518 to take into account the role that gravity will play in how the segments will be able to stably sit on its associated print base when the segment is being printed. At block 522, “Weight Distribution, Size, Shape, Gravity, and Dimensional analysis is performed. Based on the shape, dimension, and height of the 3D model to be printed, the system will estimate the weight distribution of the segments of the 3D physical object based on the shape and dimension of the segments. The analysis performed at block 520 can rely on result from block 514, as well as information from an aggregate object database 522 and a split sample data 524. The aggregate object database 522 can be implemented as the segmented 3D model repository 140 (shown in FIGS. 1 and 2A). The split sample data 524 a sequencing of the segments is performed based on the number of split segment portions, the system will sequence the split segment portions and will assign the same to individual printheads of the MPH 3D printer 120.

At block 526, STAGE 3 depicts the actual execution of the 3D model segments by a controller 110, 110A to control the corresponding printheads of the MPH 120 to print segments of the 3D physical object on corresponding print bases 206A, 206B, 206C. Block 528 is operable to ensure that printing operations follow the common polar axis of each segment of the 3D physical object that is being printed. In general, the polar axis is an imaginary line that extends through the north and south geographic poles. At block 530, the segments are moved from their associated print bases and assembled. In some embodiments, the operations at block 530 are performed by the robotic arm 532 in the manner previously described herein. In some embodiments of the invention, while assembling the segments, the robotic gripper can grip the segment, and the collapsible print bases are gradually removed (or collapsed). In embodiments of the invention, block 530 can include each segment can be assembled with its lower level by creating an appropriate locking mechanism (e.g., groves and matching ridges at the interface between adjacent segments) so that proper attachment can be done. In some embodiments of the invention, the locking mechanism structure can be incorporated into the 3D model segments that print a corresponding segment with the necessary locking mechanism (e.g., the previously-described grooves and matching ridges). After block 530, an inspection of the assembled 3D physical object can be performed.

At block 534, STAGE 4 depicts the gathering of iteration feedback and historical data. Throughout the modeling planning, usage, and printing processing, the data will be uploaded into a knowledge corpus (e.g., repository 140) for future reference. Information generated at block 534, fed back to the database 522 to update the knowledge corpus with positive and negative feedback, which will allow for further and future object recognition for optimal printing techniques. The data gathered at blocks 534 can be used to train ML algorithms/models used in embodiments of the invention (e.g., at the CAD segmentation module 132) to make the models smarter over time. Thus, future modeling can reinforce positive behaviors and eliminate negative elements or work flows within the overall process. This will enable an intelligent workflow over time as positive reinforcement will persist.

At decision block 536, the methodology 500 determines whether printing has completed. If the answer to the inquiry at decision block 536 is yes, the methodology 500 moves to block 540 and ends. If the answer to the inquiry at decision block 536 is no, the methodology 500 moves to block 538 and performs additional iterations of the methodology 500 then returns to decision block 536.

Additional options for implementing the various ML algorithms and model used in connection with embodiments of the invention are depicted in FIGS. 6 and 7. Machine learning models configured and arranged according to embodiments of the invention will be described with reference to FIG. 6. Detailed descriptions of an example computing environment 800 and network architecture capable of implementing embodiments of the invention described herein will be provided with reference to FIG. 8.

FIG. 6 depicts a block diagram showing a classifier system 600 capable of implementing various aspects of the invention described herein. More specifically, the functionality of the system 600 is used in embodiments of the invention to generate various models and/or sub-models that can be used to implement computer functionality in embodiments of the invention. The system 600 includes multiple data sources 602 in communication through a network 604 with a classifier 610. In some aspects of the invention, the data sources 602 can bypass the network 604 and feed directly into the classifier 610. The data sources 602 provide data/information inputs that will be evaluated by the classifier 610 in accordance with embodiments of the invention. The data sources 602 also provide data/information inputs that can be used by the classifier 610 to train and/or update model(s) 616 created by the classifier 610. The data sources 602 can be implemented as a wide variety of data sources, including but not limited to, sensors configured to gather real time data, data repositories (including training data repositories), and outputs from other classifiers. The network 604 can be any type of communications network, including but not limited to local networks, wide area networks, private networks, the Internet, and the like.

The classifier 610 can be implemented as algorithms executed by a programmable computer such as the computing environment 800 (shown in FIG. 8). As shown in FIG. 6, the classifier 610 includes a suite of machine learning (ML) algorithms 612; natural language processing (NLP) algorithms 614; and model(s) 616 that are relationship (or prediction) algorithms generated (or learned) by the ML algorithms 612. The algorithms 612, 614, 616 of the classifier 610 are depicted separately for ease of illustration and explanation. In embodiments of the invention, the functions performed by the various algorithms 612, 614, 616 of the classifier 610 can be distributed differently than shown. For example, where the classifier 610 is configured to perform an overall task having sub-tasks, the suite of ML algorithms 612 can be segmented such that a portion of the ML algorithms 612 executes each sub-task and a portion of the ML algorithms 612 executes the overall task. Additionally, in some embodiments of the invention, the NLP algorithms 614 can be integrated within the ML algorithms 612.

The NLP algorithms 614 includes text recognition functionality that allows the classifier 610, and more specifically the ML algorithms 612, to receive natural language data (e.g., text written as English alphabet symbols) and apply elements of language processing, information retrieval, and machine learning to derive meaning from the natural language inputs and potentially take action based on the derived meaning. The NLP algorithms 614 used in accordance with aspects of the invention can also include speech synthesis functionality that allows the classifier 610 to translate the result(s) 620 into natural language (text and audio) to communicate aspects of the result(s) 620 as natural language communications.

The NLP and ML algorithms 614, 612 receive and evaluate input data (i.e., training data and data-under-analysis) from the data sources 602. The ML algorithms 612 include functionality that is necessary to interpret and utilize the input data's format. For example, where the data sources 602 include image data, the ML algorithms 612 can include visual recognition software configured to interpret image data. The ML algorithms 612 apply machine learning techniques to received training data (e.g., data received from one or more of the data sources 602) in order to, over time, create/train/update one or more models 616 that model the overall task and the sub-tasks that the classifier 610 is designed to complete.

Referring now to FIGS. 6 and 7 collectively, FIG. 7 depicts an example of a learning phase 700 performed by the ML algorithms 612 to generate the above-described models 616. In the learning phase 700, the classifier 610 extracts features from the training data and converts the features to vector representations that can be recognized and analyzed by the ML algorithms 612. The feature vectors are analyzed by the ML algorithm 612 to “classify” the training data against the target model (or the model's task) and uncover relationships between and among the classified training data. Examples of suitable implementations of the ML algorithms 612 include but are not limited to neural networks, support vector machines (SVMs), logistic regression, decision trees, hidden Markov Models (HMMs), etc. The learning or training performed by the ML algorithms 612 can be supervised, unsupervised, or a hybrid that includes aspects of supervised and unsupervised learning. Supervised learning is when training data is already available and classified/labeled. Unsupervised learning is when training data is not classified/labeled so must be developed through iterations of the classifier 610 and the ML algorithms 612. Unsupervised learning can utilize additional learning/training methods including, for example, clustering, anomaly detection, neural networks, deep learning, and the like.

When the models 616 are sufficiently trained by the ML algorithms 612, the data sources 602 that generate “real world” data are accessed, and the “real world” data is applied to the models 616 to generate usable versions of the results 620. In some embodiments of the invention, the results 620 can be fed back to the classifier 610 and used by the ML algorithms 612 as additional training data for updating and/or refining the models 616.

In aspects of the invention, the ML algorithms 612 and the models 616 can be configured to apply confidence levels (CLs) to various ones of their results/determinations (including the results 620) in order to improve the overall accuracy of the particular result/determination. When the ML algorithms 612 and/or the models 616 make a determination or generate a result for which the value of CL is below a predetermined threshold (TH) (i.e., CL<TH), the result/determination can be classified as having sufficiently low “confidence” to justify a conclusion that the determination/result is not valid, and this conclusion can be used to determine when, how, and/or if the determinations/results are handled in downstream processing. If CL>TH, the determination/result can be considered valid, and this conclusion can be used to determine when, how, and/or if the determinations/results are handled in downstream processing. Many different predetermined TH levels can be provided. The determinations/results with CL>TH can be ranked from the highest CL>TH to the lowest CL>TH in order to prioritize when, how, and/or if the determinations/results are handled in downstream processing.

In aspects of the invention, the classifier 610 can be configured to apply confidence levels (CLs) to the results 620. When the classifier 610 determines that a CL in the results 620 is below a predetermined threshold (TH) (i.e., CL<TH), the results 620 can be classified as sufficiently low to justify a classification of “no confidence” in the results 620. If CL>TH, the results 620 can be classified as sufficiently high to justify a determination that the results 620 are valid. Many different predetermined TH levels can be provided such that the results 620 with CL>TH can be ranked from the highest CL>TH to the lowest CL>TH.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 8 depicts an example computing environment 800 that can be used to implement aspects of the invention. Computing environment 800 contains an example of an environment for the execution of at least some of the computer code involved in performing the inventive methods, such as computer-implemented methods and computer program products 850 operable to perform three-dimensional (3D) printing using segmented 3D models having a plurality of 3D model segments. In addition to block 850, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 850, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 850 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface-type operating systems that employ a kernel. The code included in block 850 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
accessing, using a processor system, a segmented three-dimensional (3D) model of a 3D physical object, the segmented 3D model comprising a plurality of 3D model segments;
using instructions of a first 3D model segment of the plurality of 3D model segments to control a first printhead of a multiple-printhead (MPH) 3D printer to print a first segment of the 3D physical object on a first print base of the MPH 3D printer; and
using instructions of a second 3D model segment of the plurality of 3D model segments to control a second printhead of the MPH 3D printer to print a second segment of the 3D physical object on a second print base of the MPH 3D printer.

2. The computer-implemented method of claim 1, wherein the instructions of the first 3D model segment of the plurality of 3D model segments control the first printhead of the MPH 3D printer substantially in parallel with the instructions of the second 3D model segment of the plurality of 3D model segments controlling the second printhead of the MPH 3D printer.

3. The computer-implemented method of claim 1, wherein the MPH 3D printer comprises a collapsible print base comprising the first print base and the second print base.

4. The computer-implemented method of claim 3 further comprising:
controlling, using the processor system, the collapsible print base to move to a collapsed position responsive to:
a completion of the first segment of the 3D physical object; and
a completion of the second segment of the 3D physical object.

5. The computer-implemented method of claim 1, wherein the first 3D model segment and the second 3D model segment are determined based at least in part on a weight distribution of the 3D physical object.

6. The computer-implemented method of claim 1, wherein the first 3D model segment and the second 3D model segment are determined based at least in part on a shape of the 3D physical object.

7. The computer-implemented method of claim 1, wherein the first 3D model segment and the second 3D model segment are determined based at least in part on a corpus of previously-implemented segmented 3D models.

8. A computer system comprising a memory communicatively coupled to a processor system, wherein the processor system is configured to perform processor system operations comprising:
accessing a segmented three-dimensional (3D) model of a 3D physical object, the segmented 3D model comprising a plurality of 3D model segments;
using instructions of a first 3D model segment of the plurality of 3D model segments to control a first printhead of a multiple-printhead (MPH) 3D printer to print a first segment of the 3D physical object on a first print base of the MPH 3D printer; and
using instructions of a second 3D model segment of the plurality of 3D model segments to control a second printhead of the MPH 3D printer to print a second segment of the 3D physical object on a second print base of the MPH 3D printer.

9. The computer system of claim 8, wherein the instructions of the first 3D model segment of the plurality of 3D model segments control the first printhead of the MPH 3D printer substantially in parallel with the instructions of the second 3D model segment of the plurality of 3D model segments controlling the second printhead of the MPH 3D printer.

10. The computer system of claim 8, wherein the MPH 3D printer comprises a collapsible print base comprising the first print base and the second print base.

11. The computer system of claim 10 further comprising:
controlling, using the processor system, the collapsible print base to move to a collapsed position responsive to:
a completion of the first segment of the 3D physical object; and
a completion of the second segment of the 3D physical object.

12. The computer system of claim 8, wherein the first 3D model segment and the second 3D model segment are determined based at least in part on a weight distribution of the 3D physical object.

13. The computer system of claim 8, wherein the first 3D model segment and the second 3D model segment are determined based at least in part on a shape of the 3D physical object.

14. The computer system of claim 8, wherein the first 3D model segment and the second 3D model segment are determined based at least in part on a corpus of previously-implemented segmented 3D models.

15. A computer program product comprising a computer readable program stored on a computer readable storage medium, wherein the computer readable program, when executed on a processor system, causes the processor system to perform processor system operations comprising:
accessing a segmented three-dimensional (3D) model of a 3D physical object, the segmented 3D model comprising a plurality of 3D model segments;
using instructions of a first 3D model segment of the plurality of 3D model segments to control a first printhead of a multiple-printhead (MPH) 3D printer to print a first segment of the 3D physical object on a first print base of the MPH 3D printer; and
using instructions of a second 3D model segment of the plurality of 3D model segments to control a second printhead of the MPH 3D printer to print a second segment of the 3D physical object on a second print base of the MPH 3D printer.

16. The computer program product of claim 15, wherein the instructions of the first 3D model segment of the plurality of 3D model segments control the first printhead of the MPH 3D printer substantially in parallel with the instructions of the second 3D model segment of the plurality of 3D model segments controlling the second printhead of the MPH 3D printer.

17. The computer program product of claim 15, wherein the MPH 3D printer comprises a collapsible print base comprising the first print base and the second print base.

18. The computer program product of claim 17 further comprising:
controlling, using the processor system, the collapsible print base to move to a collapsed position responsive to:
a completion of the first segment of the 3D physical object; and
a completion of the second segment of the 3D physical object.

19. The computer program product of claim 15, wherein the first 3D model segment and the second 3D model segment are determined based at least in part on a weight distribution of the 3D physical object.

20. The computer program product of claim 15, wherein:
the first 3D model segment and the second 3D model segment are determined based at least in part on a shape of the 3D physical object; and
the first 3D model segment and the second 3D model segment are determined based at least in part on a corpus of previously-implemented segmented 3D models.
